(19) United States
(12) Patent Application Publication
(10) Pub. No.: US 2006/0269145 A1
(43) Pub. Date: Nov. 30, 2006

(54) Method and system for determining object pose from images

(75) Inventor: Timothy Roberts, Fife (GB)

Correspondence Address: EDWARDS & ANGELL, LLP, P.O. BOX 55874, BOSTON, MA, 02205, US

(73) Assignee: The University of Dundee, Dundee (GB)

(21) Appl. No.: 10/553,664

(22) PCT Filed: Apr. 8, 2004
(86) PCT No.: PCT/GB04/01545

§ 371 Date: Jul. 26, 2006

(30) Foreign Application Priority Data
Apr. 17, 2003 (GB) 0308943.0

(51) Int. Cl. G06K 9/62; G06K 9/64

(52) U.S. Cl. 382/228; 382/217

(57) ABSTRACT

A method and system for identifying an object or structured parts of an object in an image. A set of templates are created for each of a number of the parts of the object and the templates are applied to an area of interest in an image where it is hypothesised that an object part is present. The image is analysed to determine the probability that it contains the object part. Thereafter, other templates are applied to other areas of interest in the image to determine the probability that this area of interest belongs to a corresponding object part. The templates are then arranged in a configuration and the likelihood that the configuration represents an object or structured parts of an object is calculated. This is calculated for other configurations and the configuration that is most likely to represent an object or structured part of an object is determined. The method and system can be applied to creating a markerless motion capture system and has other applications in image processing.

The present invention relates to a method and system for determining object pose from images such as still photographs, films or the like. In particular, the present invention is designed to allow a user to obtain a detailed estimation of the pose of a body, particularly a human body, from real world images with unconstrained image features.

In the case of the human body, the task of obtaining pose information is made difficult because of the large variation in human appearance. Sources of variation include the scale, viewpoint, surface texture, illumination, self-occlusion, object-occlusion, body structure and clothing shape. In order to deal with these many complicating factors, it is common, in the prior art, to use a high level hand built shape model in which points on this shape model are associated with image measurements. A score can be computed and a search performed to find the best solutions to allow the pose of the body to be determined.

A second approach identifies parts of the body and then assembles them into the best configuration. This approach does not model self-occlusion. Both approaches tend to rely on a fixed number of parts being parameterised. In addition, many human pose estimation methods use rigid geometric primitives such as cones and spheres to model body parts.

Furthermore, existing techniques identify the boundary between the foreground in which the body part is situated and the background containing the rest of the scene shown in the image, by the detection of the edges between these two features.

Where the pose of a body is to be tracked through a series of images on a frame by frame basis, localised sampling of the images is used in the full dimensional pose space. The approach usually requires manual initialisation and does not recover from significant tracking errors.

It is an object of the present invention to provide an improved method and system for identifying in an image the relative positions of parts of a pre-defined object (object pose) and to use this identification to analyse images in a number of technological applications areas.

In accordance with a first aspect of the present invention there is provided a method of identifying an object or structured parts of an object in an image, the method comprising the steps of:

creating a set of templates, the set containing a template for each of a number of predetermined object parts and applying said template to an area of interest in an image where it is hypothesised that an object part is present;

analysing image pixels in the area of interest to determine the likelihood that it contains the object part;

applying other templates from the set of templates to other areas of interest in the image to determine the probability that said area of interest belongs to a corresponding object part and arranging the templates in a configuration;

calculating the likelihood that the configuration represents an object or structured parts of an object; and calculating other configurations and comparing said configurations to determine the configuration that is most likely to represent an object or structured part of an object.

Preferably, the probability that an area of interest contains an object part is calculated by calculating a transformation from the co-ordinates of a pixel in the area of interest to the template.

Preferably, the step of analysing the area of interest further comprises identifying the dissimilarity between foreground and background of the template.

Preferably, the step of analysing the area of interest further comprises calculating a likelihood ratio based on a determination of the dissimilarity between foreground and background features of a transformed template.

Preferably, the templates are applied by aligning their centres, orientations in 2D or 3D and scales to the area of interest on the image.

Preferably, the template is a probabilistic region mask in which values indicate a probability of finding a pixel corresponding to an object part.

Optionally, the probabilistic region mask is estimated by segmentation of training images.

Optionally, the mask is a binary mask.

Preferably, the image is an unconstrained scene.

Preferably, the step of calculating the likelihood that the configuration represents an object or a structured part of an object comprises calculating a likelihood ratio for each object part and calculating the product of said likelihood ratios.

Preferably, the step of calculating the likelihood that the configuration represents an object comprises determining the spatial relationship of object part templates.

Preferably, the step of determining the spatial relationship of the object part templates comprises analysing the configuration to identify common boundaries between pairs of object part templates.

Optionally, the step of determining the spatial relationship of the object part templates requires identification of object parts having similar characteristics and defining these as a sub-set of the object part templates.

Preferably, the step of calculating the likelihood that the configuration represents an object or structured part of an object comprises calculating a link value for object parts which are physically connected.

Preferably, the step of comparing said configurations comprises iteratively combining the object parts and predicting larger configurations of body parts.

Preferably, the object is a human or animal body.

In accordance with a second aspect of the invention there is provided a system for identifying an object or structured parts of an object in an image, the system comprising:

a set of templates, the set containing a template for each of a number of predetermined object parts applicable to an area of interest in an image where it is hypothesised that an object part is present;

analysis means for determining the likelihood that the area of interest contains the object part;

configuring means capable of arranging the applied templates in a configuration;

calculating means to calculate the likelihood that the configuration represents an object or structured parts of an object for a plurality of configurations; and

comparison means to compare configurations so as to determine the configuration that is most likely to represent an object or structured part of an object.

Preferably, the system further comprises imaging means capable of providing an image for analysis.

More preferably, the imaging means is a stills camera or a video camera.

Preferably, the analysis means is provided with means for identifying the dissimilarity between foreground and background of the template.

Preferably, the analysis means calculates the probability that an area of interest contains an object part by calculating a transformation from the co-ordinates of a pixel in the area of interest to the template.

Preferably, the analysis means calculates a likelihood ratio based on a determination of the dissimilarity between foreground and background features of a transformed template.

Preferably, the templates are applied by aligning their centres, orientations (in 2D or 3D) and scales to the area of interest on the image.

Preferably, the template is a probabilistic region mask in which values indicate a probability of finding a pixel corresponding to an object part.

Optionally, the probabilistic region mask is estimated by segmentation of training images.

Optionally, the mask is a binary mask.

Preferably, the image is an unconstrained scene.

Preferably, the calculating means calculates a likelihood ratio for each object part and calculating the product of said likelihood ratios.

Preferably, the likelihood that the configuration represents an object comprises determining the spatial relationship of object part templates.

Preferably, the spatial relationship of the object part templates is calculated by analysing the configuration to identify common boundaries between pairs of object part templates.

Preferably, the spatial relationship of the object part templates is determined by identifying object parts having similar characteristics and defining these as a sub-set of the object part templates.

Preferably, the calculating means is capable of calculating a link value for object parts which are physically connected.

Preferably, the calculating means is capable of iteratively combining the object parts in order to predict larger configurations of body parts.

Preferably, the object is a human or animal body.

In accordance with a third aspect of the present invention there is provided, a computer program comprising program instructions for causing a computer to perform the method of the first aspect of the invention.

Preferably, the computer program is embodied on a computer readable medium.

In accordance with a fourth aspect of the present invention there is provided a carrier having thereon a computer program comprising computer implementable instructions for causing a computer to perform the method of the first aspect of the present invention.

In accordance with a fifth aspect of the present invention there is provided a markerless motion capture system comprising imaging means and a system for identifying an object or structured parts of an object in an image of the second aspect of the present invention.

The present invention will now be described by way of example only, with reference to the accompanying drawings in which:

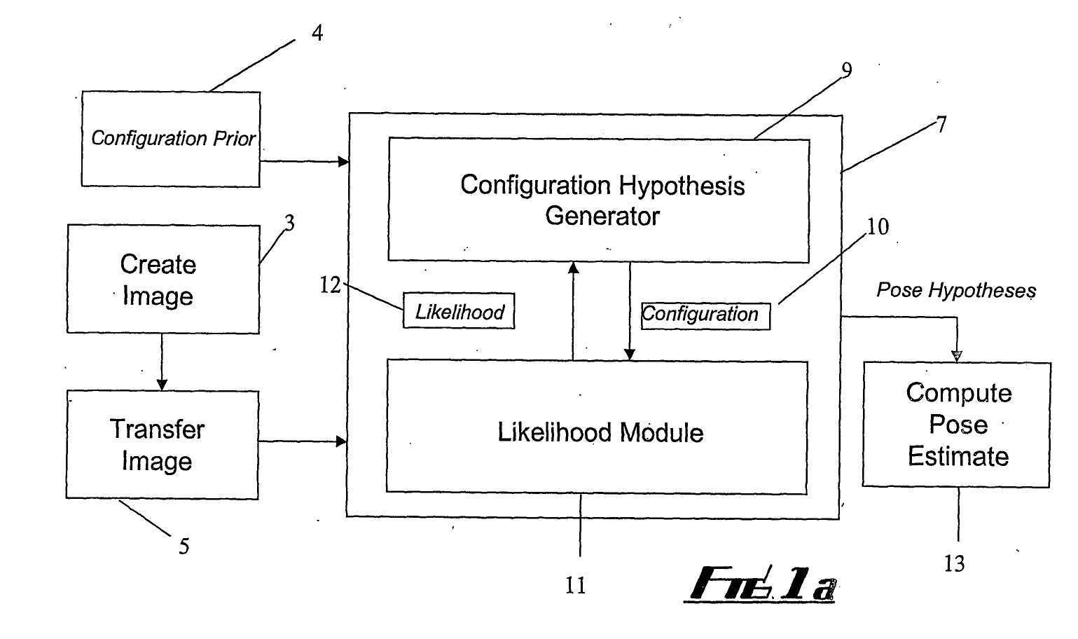

FIGS. 1a is a flow diagram showing the operational steps used in implementing an embodiment of the present invention and FIG. 1b is a detailed flow diagram of the steps provided in the likelihood module of the present invention;

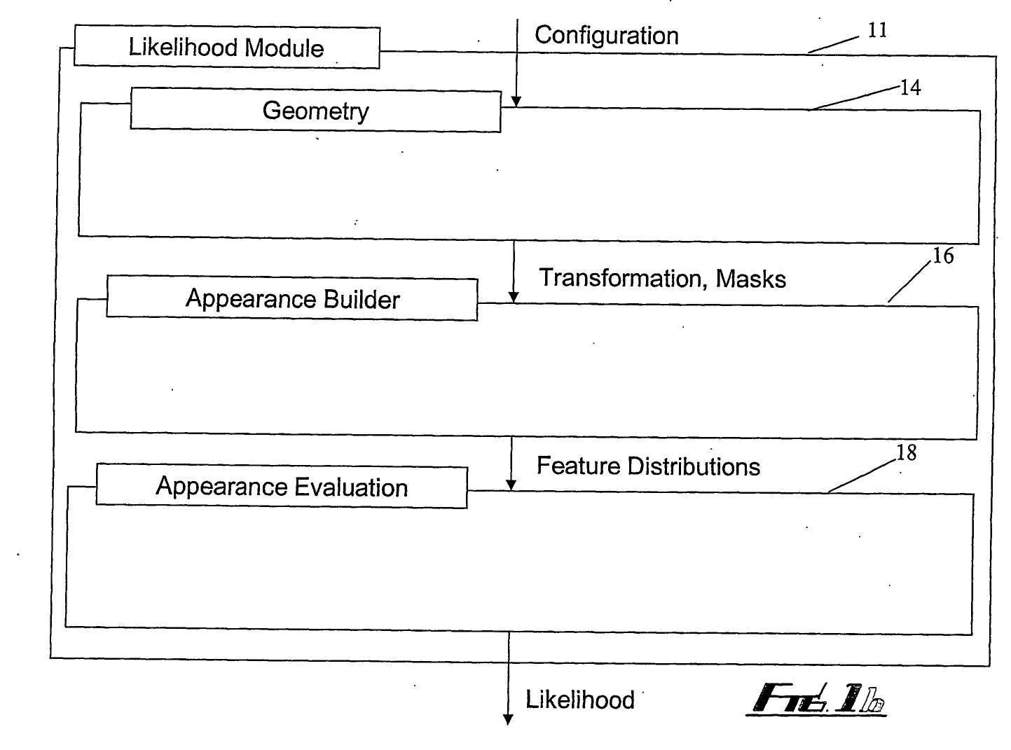

FIGS. 2a(i) to 2(viii) show a set of templates for a number of body parts and FIG. 2b (i) to (iii) shows a reduced set of templates;

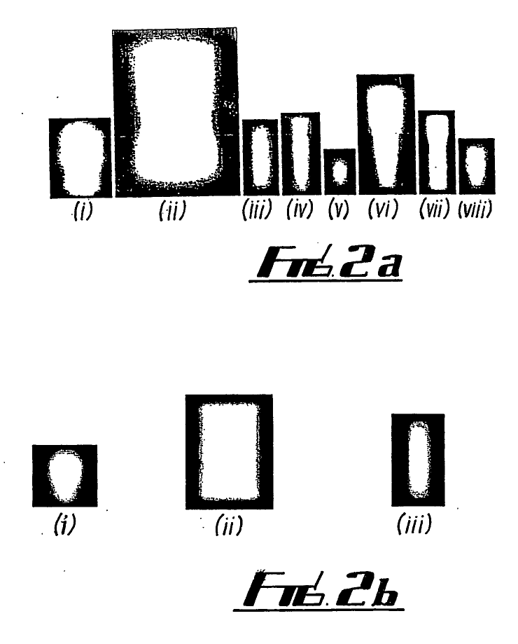

FIG. 3a shows a lower leg template, FIG. 3b shows the lower leg template on an image and FIG. 3c illustrates the feature distributions of the background and foreground regions of the image at or near the template;

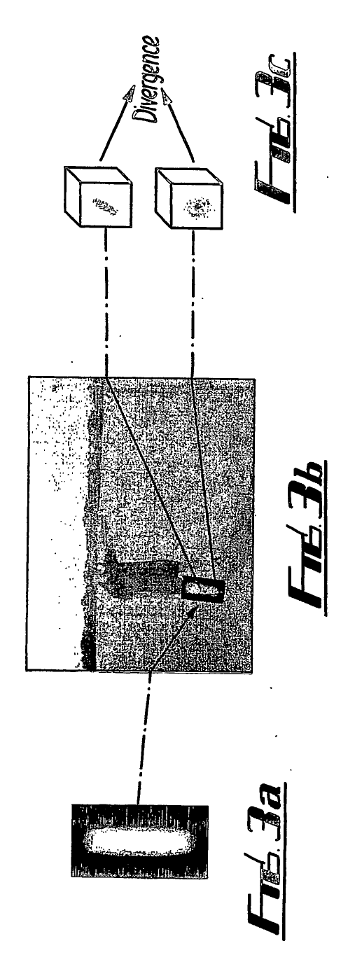

FIG. 4a is a graph comparing the probability density of foreground and background appearance for on and \overline{on} (\overline{on} meaning not on the part) part configurations for a head template and FIG. 4b is a graph of the log of the resultant likelihood ratio;

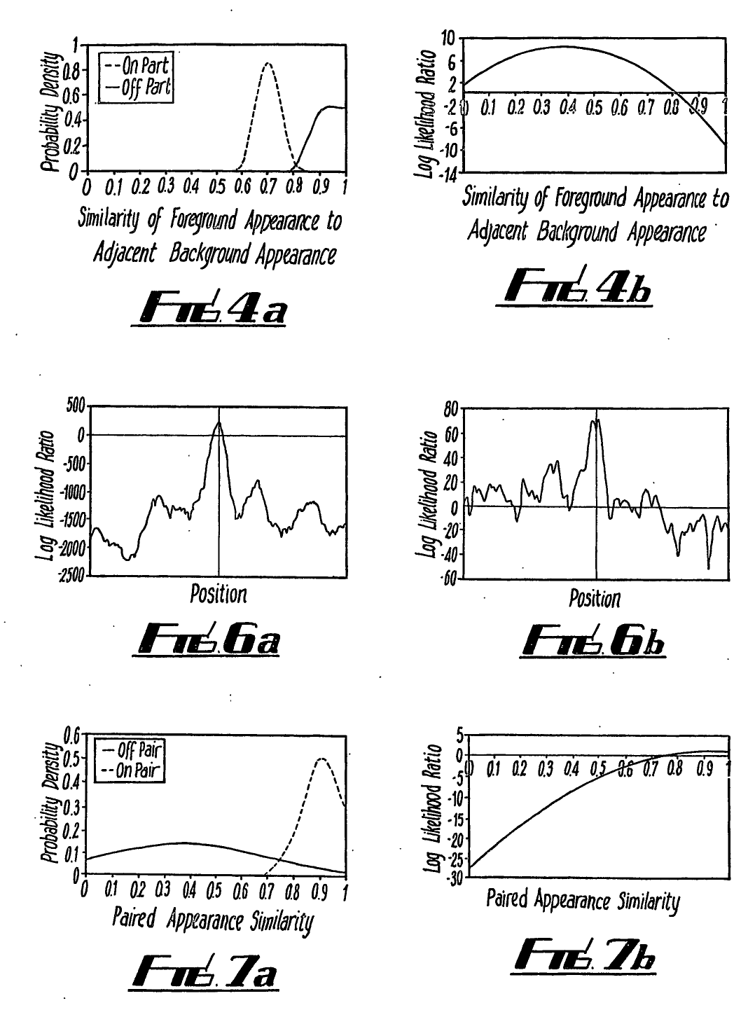

FIG. 5a is a column of typical images from both outdoor and indoor environments; FIG. 5b is a column is a projection of the positive log likelihood from the masks or templates and FIG. 5c is the projection of positive log likelihood from the prior art edge based model;

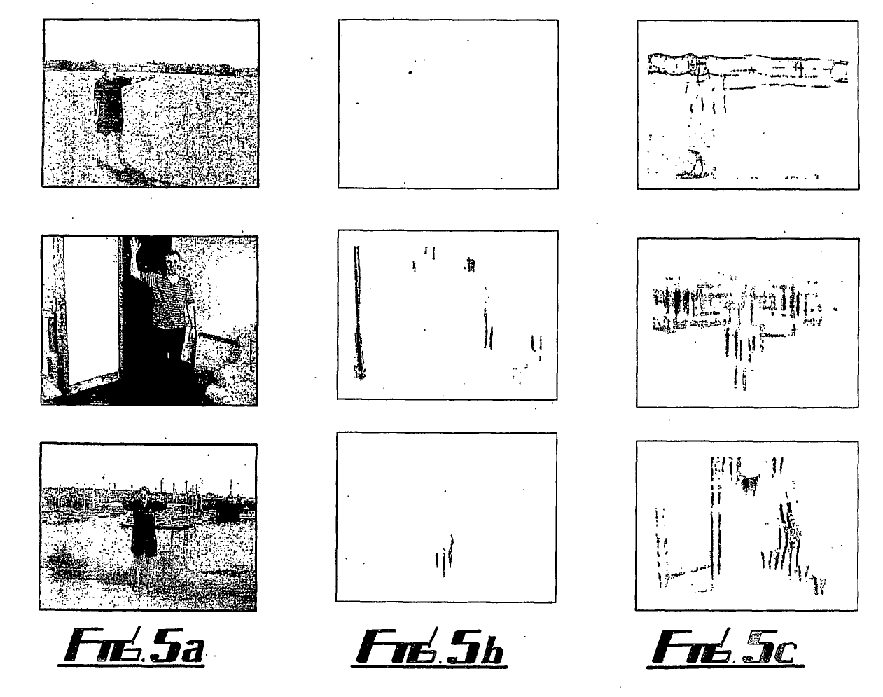

FIG. 6a is a graph of the spatial variation of the learnt log likelihood ratios of the present invention and FIG. 6b is a graph of the spatial variation of the learnt log likelihood ratios of the prior art edge model;

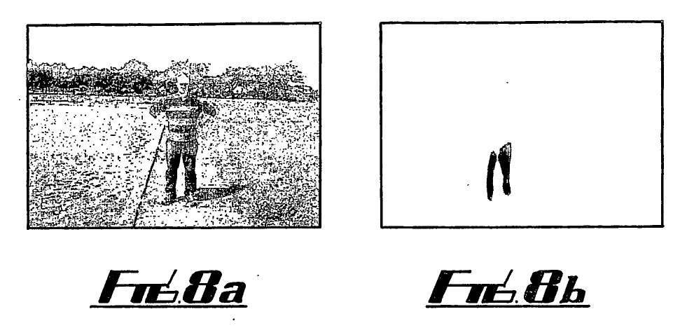

FIG. 7a is a graph of the probability density for paired and non-paired configurations and FIG. 7b is a plot of the log of the resulting likelihood ratio;

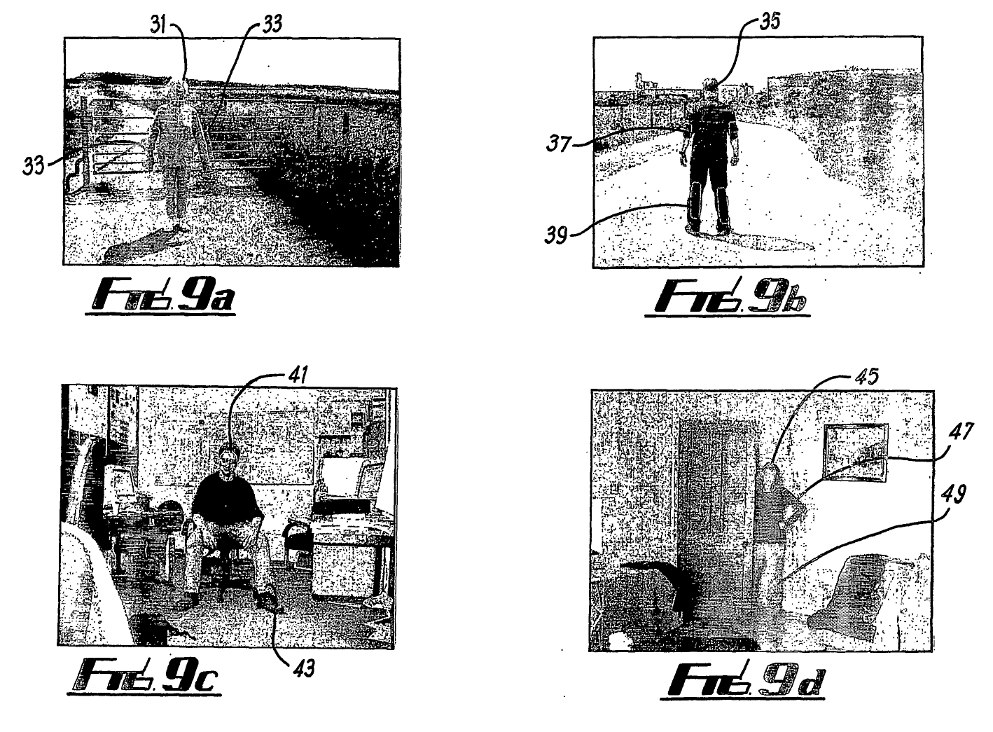

FIG. 8a depicts an image of a body in an unconstrained background and FIG. 8b illustrates the projection of the likelihood ratio for the paired response to a person's lower right leg image; and

FIGS. 9a to 9d show results from a search for partial pose configurations.

The present invention provides a method and system for identifying an object such as a body in an image. The technology used to achieve this result is typically a combination of computer hardware and software.

FIG. 1a shows a flow diagram of an embodiment of the present invention in which a still photograph of an unconstrained scene is analysed to identify the position of an object, in this example, a human body within the scene.

Firstly, an image is created 3 using standard photographic techniques or using digital photography and the image is transferred 5 into a computer system adapted to operate the method according to the present invention. ‘Configuration prior’ is data on the expected configuration of the body based upon known earlier body poses or known constraints on body pose such as the basic stance adopted by a person before taking a golf swing. This data can be used to assist with the overall analysis of body pose.

A configuration hypothesis generator of a known type creates a configuration 10 created. The likelihood module 11 creates a score or likelihood 14 which is fed back to the configuration hypothesis generator 9. Pose hypotheses are created and a pose output is selected which is typically the best pose.

FIG. 1b shows the operation of the likelihood generator in more detail. A geometry analysis module 14 is used to analyse the geometry of body parts by finding a mask for each part in the configuration and using the configuration to determine a transformation for each part from the part's mask to the image and then inverting this transformation.

An appearance builder module 16 is used to analyse the pixels in an image in the following manner. For every pixel in the image, the inverse transform is used to find the corresponding position on each part's mask and the probability from the mask is used to add the image features at that image location to the feature distributions.

An appearance evaluation module 18 is used to compare the foreground and background feature distributions for each part to get the single part likelihood. The foreground distributions are compared for each symmetric part to get the symmetry likelihood. The cues are combined to get the total likelihood.

Details of the manner in which the above embodiment of the present invention is implemented will now be given with reference to FIGS. 2 to 9.

The shape of each of a number of body parts is modelled in the following manner. The body part, labelled here by i (iε1 . . . N), is represented using a single probabilistic region template, Mᵢ, which represents the uncertainty in the part's shape without attempting to enable shape instances to be accurately reconstructed. This approach allows for efficient sampling of the body part shape where the shape is obscured by a cover if, for example the subject is wearing loose fitting clothing.

The probability that a pixel in the image at position (x, y) belongs to a hypothesised body part i is given by Mᵢ(Tᵢ(x,y)) where Tᵢ is a linear transformation from image co-ordinates to template or mask co-ordinates determined by the part's centre, (x_{c}, y_{c}), image plane rotation, θ, elongation, e, and scale, s. The elongation parameter alters the aspect ratio of the template and is used to approximate rotation in depth about one of the part's axes.

The probabilities in the template are estimated from example shapes in the form of binary masks obtained by manual segmentation of training images in which the elongation is maximal (i.e. in which the major axis of the part is parallel to the image plane). These training examples are aligned by specifying their centres, orientations and scales. Un-parameterised pose variations are marginalised over, allowing a reduction in the size of the state space. Specifically, rotation about each limb's major axis is marginalised since these rotations are difficult to observe. The templates can also be constrained to be symmetric about their minor axis.

FIGS. 2a(i) to (viii) show templates with masks for human body parts. FIG. 2a(i) is a mask of a head, FIG. 2a(ii) is a mask of a torso, FIG. 2a(iii) is a mask of an upper arm, FIG. 2a(iv) is a mask of a lower arm, FIG. 2a(v) is a mask of a hand, FIG. 2a(vi) is a mask of an upper leg, FIG. 2a(vii) is a mask of a lower leg and FIG. 2a(viii) is a mask of a foot.

In this example, upper and lower arm and leg parts can reasonably be represented using a single template. This reduced number of masks greatly improves the sampling efficiency.

FIG. 2b (i) to (iii) show some learnt probabilistic region templates. FIG. 2b(i) shows a head mask, FIG. 2b(ii) shows a torso mask and FIG. 2b(iii) shows a leg mask used in this example.

The uncertain regions in these templates exist because of (i) 3D shape variation due to change of clothing and identity of the body, (ii) rotation in depth about the major axis, and (iii) inaccuracies in the alignment and manual segmentation of the training images.

In order to detect the body parts in an image, the dissimilarity between the appearance of the foreground and background of a transformed probabilistic region as illustrated in FIG. 3 is determined. These appearances are represented as Probability Density Functions (PDFs) of intensity and chromaticity image features, resulting in 3D probability distributions.

In general, local filter responses could also be used to represent the appearance. Since texture can often result in multi-modal distributions, each PDF is encoded as a histogram (marginalised over position). For scenes in which the body parts appear small, semi-parametric density estimation methods such as Gaussian mixture models can be used.

The foreground appearance histogram for part i, denoted here by Fᵢ, is formed by adding image features from the part's supporting region proportional to Mᵢ(Tᵢ(x,y)). Similarly, the adjacent background appearance distribution, Bᵢ, is estimated by adding features proportional to 1−Mᵢ(Tᵢ(x,y)).

The foreground appearance will be less similar to the background appearance for configurations that are correct (denoted by on) than incorrect (denoted by \overline{on}). Therefore, a PDF of the Bhattacharya measure (for measuring the divergence of the probability density functions) given by Equation (1) is learnt for on and \overline{on} configurations.

The on distribution is estimated from data obtained by specifying the transformation parameters to align the probabilistic region template to be on parts that are neither occluded nor overlapping. The \overline{on} distribution is estimated by generating random alignments elsewhere in sample images of outdoor and indoor scenes.

The on PDF can be adequately represented by a Guassian distribution. Equation (2) defines SINGLEᵢ as the ratio of the on and \overline{on} distributions. This is used to score a single body part configuration and is plotted in FIG. 3.

$$\begin{matrix}I ( {F}_{i} , {B}_{i} ) = {\sum }_{f} \sqrt{{F}_{i} ( f ) \times {B}_{i} ( f )} & ( 1 ) \\ {SINGLE}_{i} = \frac{p ( I ( {F}_{i} , {B}_{i} ) \vert on )}{p ( I ( {F}_{i} , {B}_{i} ) \vert \overline{on )}} & ( 2 )\end{matrix}$$

FIG. 4a is a graph comparing the probability density of foreground and background appearance for on and \overline{on} part configurations for a head template and FIG. 4b is a graph of the log of the resultant likelihood ratio. It is clear from FIG. 3a that the probability density distributions for the on and \overline{on} distributions are well separated.

The present invention also provides enhanced discrimination of body parts by defining adjoining and non-adjoining regions.

Detection of single body parts, can be improved by distinguishing positions where the background appearance is most likely to differ from the foreground appearance. For example, due to the structure of clothing, when detecting an upper arm, adjoining background areas around the shoulder joint are often similar to the foreground appearance. The histogram model proposed thus far, which marginalises appearance over position, does not use this information optimally.

To enhance discrimination, two separate adjacent background histograms are constructed, one for adjoining regions and another for non-adjoining regions. In the model, it is expected that the non-adjoining region appearance will be less similar to the foreground appearance than the adjoining region appearance.

The adjoining and non-adjoining regions can be specified manually during training by defining a hard threshold. Alternatively, a probabilistic approach, where the regions are estimated by marginalising over the relative pose between adjoining parts to get a low dimensional model could be used.

The use of information from adjoining regions is particularly useful where bottom-up identification of body parts is required.

FIGS. 5a to 5c show a set of images (FIG. 5a) which have been analysed for part detection purposes using the present invention (FIG. 5b) and by using a prior art method (FIG. 4c). FIG. 5a is a column of typical images from both outdoor and indoor environments, FIG. 5b is a column is a projection of the positive log likelihood from the masks or templates showing the maximum likelihood of the presence of body parts and FIG. 5c is the projection of positive log likelihood from the prior art edge based model.

The column FIG. 5b shows the projection of the likelihood ratio computed using Equation (2) onto typical images containing significant background information or clutter. The top image of FIG. 5b shows the response for a head while the other two images show the response of a vertically-orientated limb filter.

It can be seen that the technique of the present invention is highly discriminatory, producing relatively few false maxima in comparison with the prior art system. Although images were acquired using various cameras, some with noisy colour signals, system parameters were fixed for all test images.

In order to provide a comparison with an alternative method, the responses obtained by comparing the hypothesised part boundaries with edge responses were computed. These are shown in FIG. 5c. Orientations of significant edge responses for foreground and background configurations were learned (using derivatives of the probabilistic region template), treated as independent and normalised for scale. Contrast normalisation was not used. Other formulations (e.g. averaging) proved to be weaker on the scenes under consideration. The responses using this method are clearly less discriminatory.

FIGS. 6a and 6b compare the spatial variation of the Log of Learnt likelihood ratios of the present invention and the prior art edge-based likelihood system for a head. In both FIGS. 6a and 6b, the correct position is centred and indicated by the vertical line 25. The horizontal bar 27 in both FIGS. 6a and 6b corresponds to a likelihood ratio of more than 1 which is the measure of whether an object is more likely to be a head than not. As can be seen from comparing FIGS. 6a and 6b, FIG. 6b has a large number of positions where the likelihood is greater than 1, whereas only a single instance of this occurs in FIG. 6a.

The edge response, whilst indicative of the correct position of body parts, has significant false positive likelihood ratios. The part likelihood calculation used in the present invention is more expensive to compute, however, it is far more discriminatory and as a result, fewer samples are needed when performing pose search, leading to an overall computational performance benefit. Furthermore, the collected foreground histograms can be useful for other likelihood measurements as described below.

Since any single body part likelihood will probably result in false positives, the present invention provides for the encoding of higher order relationships between body parts to improve discrimination. This is accomplished by encoding an expectation of structure in the foreground appearance and the spatial relationship of body parts.

Configurations containing more than one body part can be represented using an extension of the probabilistic region approach described above. In order to account for self-occlusion, the pose space is represented by a depth ordered set, V, of probabilistic regions with parts sharing a common scale parameter, s. When taken together, the templates determine the probability that a particular image feature belongs to a particular part's foreground or background. More specifically, the probability that an image feature at position (x,y) belongs to the foreground appearance of part i is given by Mᵢ(Tᵢ(x,y))×Πⱼ(1−Mⱼ(Tⱼ(x,y)) where j labels closer, instantiated parts.

Therefore, a list of paired body parts is specified and the background appearance histogram is constructed from features weighted by Πₖ(1−Mₖ(Tₖ(x,y)) where k labels all instantiated parts other than i and those paired with i.

Thus, a single image feature can contribute to the foreground and adjacent background appearance of several parts. When insufficient data is available to estimate either the foreground or the adjacent background histogram (as determined using an area threshold) the corresponding likelihood ratio is set to one.

In order to define constraints between parts, a link is introduced between parts i and j if and only if they are physically connected neighbours. Each part has a set of control points that link it to its neighbours. A link has an associated value LINK_{i,j} given by:

$${LINK}_{i , j} = \{ \begin{matrix}1 & if {δ}_{i , j} / s 〈 {Δ}_{i , j} \\ {ⅇ}^{( {δ}_{i , j} / s - {Δ}_{i , j} ) / σ} & otherwise\end{matrix} \qquad ( 3 )$$

where δ_{i,j} is the image distance between the control points of the pair, Δ_{i,j} is the maximum un-penalised distance and σ relates to the strength of penalisation. If the neighbouring parts do not link directly, because intervening parts are not instantiated, the un-penalised distance is found by summing the un-penalised distances over the complete chain. This can be interpreted as being analogous to a force between parts equivalent to a telescopic rod with a spring on each end.

A simplifying feature of the system is that certain pairs of body parts can be expected to have a similar foreground appearance to one another. For example, a person's upper left arm will nearly always have a similar colour and texture to the person's upper right arm. In the system of the present invention, the limbs are paired with their opposing parts. To encode this knowledge, a PDF of the divergence measure (computed using Equation (1)) between the foreground appearance histograms of paired parts and non-paired parts is learnt.

Equation (4) shows the resulting likelihood ratio and FIGS. 7a and 7b describe this ratio graphically. FIG. 7a shows a plot of the learnt PDFs of the foreground appearance similarity for paired and non-paired configurations. The log of the resulting likelihood ratio is shown in FIG. 7b. The higher probability of similarity is found for the paired configurations.

FIG. 8 shows a typical image projection of this ratio and shows the technique to be highly discriminatory. It limits possible configurations if one limb can be found reliably and helps reduce the likelihood of incorrect large assemblies.

$${PAIR}_{i , j} = \frac{p ( I ( {F}_{i} , {F}_{j} ) \vert {on}_{i} , {on}_{j} )}{p ( I ( {F}_{i} , {F}_{j} ) \vert \overline{{on}_{i} , {on}_{j}} )} \qquad ( 4 )$$

Learning the likelihood ratios allows a principled fusion of the various cues and principled comparison of the various hypothesised configurations. The individual likelihood ratios are combined by treating the individual likelihood ratios as being independent of one another. The overall likelihood ratio is given by Equation (5). This rewards correct higher dimensional configurations over correct lower dimensional ones.

$$R = {\prod }_{i ∈ v} {SINGLE}_{i} \times {\prod }_{i , j ∈ v} {PAIR}_{i , j} \times {\prod }_{i , j ∈ v} {LINK}_{i , j} \qquad ( 5 )$$

As is apparent from the above equation, the present invention enables different hypothesised configurations to have differing numbers of parts and yet allows a comparison to be made between them in order to decide which (partial) configuration to infer given the image evidence.

The parts in the inferred configuration may not be directly physically connected (e.g. the inferred configuration might consist of a lower leg, an arm and a head in a given scene either because the other parts are occluded or their boundaries are not readily apparent from the image).

An example of a sampling scheme useable with the present invention is described as follows.

A coarse regular scan of the image for the head and limbs is made and these results are then locally optimised. Part configurations are sampled from the resulting distribution and combined to form larger configurations which are then optimised for a fixed period of time in the full dimensional pose space.

Due to the flexibility of the parameterisation, a set of optimization methods such as genetic style combination, prediction, local search, re-ordering and re-labelling can be combined using a scheduling algorithm and a shared sample population to achieve rapid, robust, global, high dimensional pose estimation.

FIG. 9 shows results of searching for partial pose configurations. The areas enclosed by the white lines 31, 33, 35, 37, 39, 41, 43, 45, 47 and 49 identify these pose configurations. Although inter-part links are not visualised in this example, these results represent estimates of pose configurations with inter-part connectivity as opposed to independently detected parts. The scale of the model was fixed and the elongation parameter was constrained to be above 0.7.

The system of the present invention described above allows detailed, efficient estimation of human pose from real-world images.

The invention provides (i) a formulation that allows the representation and comparison of partial (lower dimensional) solutions and models other object occlusion and (ii) a highly discriminatory learnt likelihood based upon probabilistic regions that allows efficient body part detection.

The likelihood depends only on there being differences between a hypothesised part's foreground appearance and adjacent background appearance. The present invention does not make use of scene-specific background models and is, as such, general and applicable to unconstrained scenes.

The system can be used to locate and estimate the pose of a person in a single monocular image. In other examples, the present invention can be used during tracking of the person in a sequence of images by combining it with a temporal pose prior propagated from other images in the sequence. In this example, it allows tracking of the body parts to reinitialise after partial or full occlusion or after tracking of certain body parts fails temporarily for some other reason.

In a further embodiment, the present invention can be used in a multi-camera system to estimate the person's pose from several views captured simultaneously.

Many other applications follow from this ability to identify a body or structured parts of a body in an image (body pose information). In one embodiment of the present invention, the body pose information determined can be used as control inputs to drive a computer game or some other motion-driven or gesture-driven human-computer interface.

In another embodiment of the present invention, the body pose information can be used to control computer graphics, for example, an avatar.

In another embodiment of the present invention, information on the body pose of a person obtained from an image can be used in the context of an art installation or a museum installation to enable the installation to respond interactively to the person's body movements.

In another embodiment of the present invention, the detection and pose estimation of people in video images in particular can be used as part of automated monitoring and surveillance applications such as security or care of the elderly.

In another embodiment of the present invention, the system could be used as part of a markerless motion-capture system for use in animation for entertainment and gait analysis. In particular, it could be used to analyse golf swings or other sports actions. The system could also be used to analyse image/video archives or as part of an image indexing system.

Some of the features of the invention can be modified or replaced by alternatives. For example, the use of histograms could be replaced by some other method of estimating a frequency distribution (e.g. mixture models, Parzen windows) or feature representation. Different methods for comparing feature representations could be used (e.g. chi-squared, histogram intersection).

The part detectors could use other features (e.g. responses of local filters such as gradient filters, Gaussian derivatives or Gabor functions).

The parts could be parameterised to model perspective projection. The search over configurations could incorporate any number of the widely known methods for high-dimensional search instead of or in combination with the methods mentioned above.

The population-based search could use any number of heuristics to help bootstrap the search (e.g. background subtraction, skin colour or other prior appearance models, change/motion detection).

The system presented here is novel in several respects. The formulation allows differing numbers of parts to be parameterised and allows poses of differing dimensionality to be compared in a principled manner based upon learnt likelihood ratios. In contrast with current approaches, this allows a part based search in the presence of self-occlusion. Furthermore, it provides a principled automatic approach to other object occlusion. View based probabilistic models of body part shapes are learnt that represent intra and inter person variability (in contrast to rigid geometric primitives).

The probabilistic region template for each part is transformed into the image using the configuration hypothesis. The probabilistic region is also used to collect the appearance distributions for the part's foreground and adjacent background. Likelihood ratios for single parts are learnt from the dissimilarity of the foreground and adjacent background appearance distributions. This technique does not use restrictive foreground/background specific modelling.

The present invention describes better discrimination of body parts in real world images than contour to edge matching techniques. Furthermore, the use of likelihoods is less sparse and noisy, making coarse sampling and local search more effective.

Improvements and modifications may be incorporated herein without deviating from the scope of the invention.

1. A method of identifying an object or structured parts of an object in an image, the method comprising the steps of:
creating a set of templates, the set containing a template for each of a number of predetermined object parts and applying said template to an area of interest in an image where it is hypothesised that an object part is present;
analysing image pixels in the area of interest to determine the probability that it contains the object part;
applying other templates from the set of templates to other areas of interest in the image to determine the probability that said area of interest belongs to a corresponding object part and arranging the templates in a configuration;
calculating the likelihood that the configuration represents an object or structured parts of an object; and
calculating other configurations and comparing said configurations to determine the configuration that is most likely to represent an object or structured part of an object.

2. A method as claimed in claim 1 wherein, the probability that an area of interest contains an object part is calculated by calculating a transformation from the co-ordinates of a pixel in the area of interest to the template.

3. A method as claimed in claim 1 wherein, analysing the area of interest further comprises identifying the dissimilarity between foreground and background of a transformed probabilistic region.

4. A method as claimed in claim 1 wherein, analysing the area of interest further comprises calculating a likelihood ratio based on a determination of the dissimilarity between foreground and background features of a transformed template.

5. A method as claimed in claim 1 wherein, the templates are applied by aligning their centres, orientations in 2D or 3D and scales to the area of interest on the image.

6. A method as claimed in claim 1 wherein the template is a probabilistic region mask in which values indicate a probability of finding a pixel corresponding to an object part.

7. A method as claimed in claim 1 wherein, the probabilistic region mask is estimated by segmentation of training images.

8. A method as claimed in claim 1 wherein, the image is an unconstrained scene.

9. A method as claimed in claim 1 wherein, the step of calculating the likelihood that the configuration represents an object or a structured part of an object comprises calculating a likelihood ratio for each object part and calculating the product of said likelihood ratios.

10. A method as claimed in claim 1 wherein, the step of calculating the likelihood that the configuration represents an object comprises determining the spatial relationship of object part templates.

11. A method as claimed in claim 10 wherein the step of determining the spatial relationship of the object part templates comprises analysing the configuration to identify common boundaries between pairs of object part templates.

12. A method as claimed in claim 11 wherein the step of determining the spatial relationship of the object part templates requires identification of object parts having similar characteristics and defining these as a sub-set of the object part templates.

13. A method as claimed in claim 12, wherein the step of calculating the likelihood that the configuration represents an object or structured part of an object comprises calculating a link value for object parts which are physically connected.

14. A method as claimed in claim 1 wherein the step of comparing said configurations comprises iteratively combining the object parts and predicting larger configurations of body parts.

15. A method as claimed in claim 1 wherein the object is a human or animal body.

16. A system for identifying an object or structured parts of an object in an image, the system comprising:
a set of templates, the set containing a template for each of a number of predetermined object parts applicable to an area of interest in an image where it is hypothesised that an object part is present;
analysis means for determining the probability that the area of interest contains the object part;
configuring means capable of arranging the applied templates in a configuration;
calculating means to calculate the likelihood that the configuration represents an object or structured parts of an object for a plurality of configurations; and
comparison means to compare configurations so as to determine the configuration that is most likely to represent an object or structured part of an object.

17. A system as claimed in claim 16 wherein, the system further comprises imaging means capable of providing an image for analysis.

18. A system as claimed in claim 17 wherein the imaging means is a stills camera or a video camera.

19. A system as claimed in claim 18 wherein, the analysis means is provided with means for identifying the dissimilarity between foreground and background of a transformed probabilistic region.

20. A system as claimed in claim 19 wherein, the analysis means calculates the probability that an area of interest contains an object part by calculating a transformation from the co-ordinates of a pixel in the area of interest to the template.

21. A system as claimed in claim 16 wherein, the analysis means calculates a likelihood ratio based on a determination of the dissimilarity between foreground and background features of a transformed template.

22. A system as claimed in claim 16 wherein, the templates are applied by aligning their centres, orientations (in 2D or 3D) and scales to the area of interest on the image.

23. A system as claimed in claim 16 wherein the template is a probabilistic region mask in which values indicate a probability of finding a pixel corresponding to the body part.

24. A system as claimed in claim 16 wherein, the probabilistic region mask is estimated by segmentation of training images.

25. A system as claimed in claim 16 wherein, the image is an unconstrained scene.

26. A system as claimed in claim 16 wherein, the calculating means calculates a likelihood ratio for each object part and calculating the product of said likelihood ratios.

27. A system as claimed in claim 26 wherein, the likelihood that the configuration represents an object comprises determining the spatial relationship of object part templates.

28. A system as claimed in claim 27 wherein the spatial relationship of the object part templates is calculated by analysing the configuration to identify common boundaries between pairs of object part templates.

29. A system as claimed in claim 28 wherein the spatial relationship of the object part templates is determined by identifying object parts having similar characteristics and defining these as a sub-set of the object part templates.

30. A system as claimed in claim 28, wherein the calculating means is capable of calculating a link value for object parts which are physically connected.

31. (canceled)

32. A system as claimed in claim 16, wherein the calculating means is capable of iteratively combining the object parts in order to predict larger configurations of body parts.

33. (canceled)

34. A computer program comprising program instructions for causing a computer to perform the method of
creating a set of templates the set containing a template for each of a number of predetermined object parts and applying said template to an area of interest in an image where it is hypothesised that an object part is present;
analysing image pixels in the area of interest to determine the probability that it contains the object part;
applying other templates from the set of templates to other areas of interest in the image to determine the probability that said area of interest belongs to a corresponding object part and arranging the templates in a configuration;
calculating the likelihood that the configuration represents an object or structured parts of an object; and
calculating other configurations and comparing said configurations to determine the configuration that is most likely to represent an object or structured part of an object.

35. A computer program as claimed in claim 34 wherein the computer program is embodied on a computer readable medium.

36. (canceled)

37. A markerless motion capture system comprising imaging means and a system for identifying an object or structured parts of an object in an image wherein the system includes:
a set of templates, the set containing a template for each of a number of predetermined object parts
applicable to an area of interest in an image where it is hypothesised that an object part is present;
analysis means for determining the probability that the area of interest contains the object part;
configuring means capable of arranging the applied templates in a configuration;
calculating means to calculate the likelihood that the configuration represents an object or structured parts of an object for a plurality of configurations; and
comparison means to compare configurations so as to determine the configuration that is most likely to represent an object or structured part of an object.
